(19) United States
(12) Patent Application Publication
(10) Pub. No.: US 2026/0213561 A1
(43) Pub. Date: Jul. 23, 2026

(54) POWER BANK MODULE, POWER BANK AND METHOD FOR OPERATING A POWER BANK MODULE

(71) Applicant: Pfanner Schutzbekleidung GmbH, Koblach (AT)

(72) Inventor: Anton PFANNER, Hohenems (AT)

(73) Assignee: Pfanner Schutzbekleidung GmbH, Koblach (AT)

(21) Appl. No.: 19/142,895

(22) PCT Filed: Dec. 18, 2023
(86) PCT No.: PCT/EP2023/086389

§ 371 Date: Jun. 24, 2025

(30) Foreign Application Priority Data
Dec. 28, 2022 (DE) 10 2022 134 904.7

(51) Int. Cl. H02J 7/00; H02J 7/50; H02J 7/70

(52) U.S. Cl. CPC H02J 7/865; H02J 7/575; H02J 7/585; H02J 7/751; H02J 7/855

(57) ABSTRACT

A power bank module includes a PCB with a controller; rechargeable battery ports that are arranged on the PCB and connect a number of rechargeable battery packs, which are connect to the rechargeable battery ports, and the power bank module; a supply connection that is arranged on the PCB and to which a load is connected, the supply connection connects the connected load and the power bank module; a charging connection is on the PCB, wherein the charging connection connects the energy source and the power bank module; wherein the controller controls opening and closing of circuits between rechargeable battery ports, the supply connection and the charging connection so that a closed circuit that includes the one supply connection always includes only one rechargeable battery port of the rechargeable battery ports, while all the other rechargeable battery ports are electrically isolated from the supply connection.

The present invention relates to a power bank module, to a power bank and to a method for operating a power bank module.

For many jobs, especially in the forestry sector, it is necessary to wear a protective helmet. By way of example, document DE 87 14 490 U1 discloses a corresponding protective helmet that comprises a helmet shell with an interior lining that comprises a subassembly, which is in contact with the head and which, in turn, consists of at least a carrying frame, a head band and a neck band, and means for fastening this subassembly to the helmet shell.

This known protective helmet is a basic helmet that is able to be adapted to different tasks under different conditions of use by changing attachment elements. The protective helmet consists of a helmet shell and a minimum interior lining. The interior lining comprises a harness, using which the helmet is worn on the head and which ensures an impact-resistant distance between the head and the helmet shell. The protective helmet has, at the outer circumference thereof, a projection, which comprises the lateral and the rear part of the helmet, and which contains, at the lower edge, four recesses for fastening the harness and further recesses for fastening additional attachments. The basic version of the helmet is able to be used as a simple universal helmet without any add-ons. The add-ons may be added or removed as required.

Helmet accessories that are expediently able to be fastened to the protective helmet also include a helmet light, which, in particular in a similar manner to a headlamp, in particular additionally illuminates the working area of a user of the protective helmet. Such additional illumination of the working area or other areas may be expedient not only during dawn and dusk, and after dark, but also in areas shielded from daylight, such as twilight under a closed tree canopy. In order to operate the helmet light, it is necessary to carry a suitable energy storage unit, for example in the form of at least one rechargeable battery or a rechargeable battery pack. Other helmet accessories may also be dependent on a supply of electrical energy, such as a headset with a wireless receiver or Bluetooth headphones.

However, it is a disadvantageous in this case that the energy requirement increases with the number of electrical loads on the protective helmet and furthermore also increases proportionally with the duration of use, i.e. the operating time, of the electrical loads. Therefore, due to the limited energy density in batteries or rechargeable battery packs, it may be the case that the weight of the large energy storage unit that is then required makes it impossible or at least impractical to carry said energy storage unit directly on the protective helmet, while, at the same time, the replacement of a smaller-sized energy storage unit on the protective helmet is already disadvantageous with respect to a temporary deactivation of the electrical loads, which is necessary for this, during the replacement.

The object of the invention is to at least alleviate the problem mentioned above. This object is achieved by way of the subjects having the features of the independent claims. Useful configurations and developments emerge from the dependent claims.

The power bank module according to the invention comprises a PCB with a controller arranged thereon; a plurality of rechargeable battery ports that are arranged on the PCB and are configured to establish a functional connection between a number of rechargeable battery packs, which are able to be connected to the plurality of rechargeable battery ports, and the power bank module; at least one supply connection that is arranged on the PCB and to which a load is able to be connected, wherein the supply connection is configured to establish a functional connection between the connected load and the power bank module; a charging connection that is arranged on the PCB and to which an energy source is able to be connected, wherein the charging connection is configured to establish a functional connection between the energy source and the power bank module, and wherein the controller is configured to control an opening and closing of circuits between the plurality of rechargeable battery ports, the at least one supply connection and the charging connection in such a way that a closed circuit that comprises the at least one supply connection always comprises only one rechargeable battery port of the plurality of rechargeable battery ports, while all of the others of the plurality of rechargeable battery ports are electrically isolated from the supply connection. This makes it possible for a plurality of energy storage units, which are connected to the rechargeable battery ports of the power bank module, to be simultaneously mechanically connected to the power bank module that is arranged on the power bank module and to which, in turn, electrical loads are able to be connected. Mechanical replacement of a single monolithic energy storage unit, which causes an interruption to the supply of energy to a connected electrical load, can therefore be avoided. Electrical isolation should be understood in this case to mean that a flow of current, in particular a supply or charging current, is prevented. The available connections to the power bank module, that is to say the supply connection, the charging connection and the rechargeable battery ports, may, in addition to supporting or enabling such an electrically isolatable current flow, also support or enable electrical communication between the connected/available components, that is to say the electrical load, rechargeable battery packs connected to the rechargeable battery ports, the potentially connected energy source and the power bank module itself. The electrical connections, which are provided by way of the power bank module, between the available/connected components may in this way also exchange information between one another, for example type information or present status or operating information that may be relevant for the operation of the system comprising the power bank module. The power bank module may therefore act as a data bus or hub for the connected components and may itself actively participate in or even control the communication taking place.

Usefully, provision may be made for the controller to also be configured to control the opening and closing of circuits between the plurality of rechargeable battery ports, the supply connection and the charging connection in such a way that the rechargeable battery port comprised by the closed circuit changes cyclically. This measure allows the rechargeable battery packs connected to the different rechargeable battery ports to be loaded essentially evenly so that the state of charge and temperature, etc. thereof remain similar to one another while the power bank is being used.

Provision may also be made for the cyclical change between the rechargeable battery ports to be effected in a time-controlled manner or on the basis of another measurable parameter. This allows the states of the different rechargeable battery packs connected to the rechargeable battery ports to be even better adapted during operation. By way of example, the age, the maximum rechargeable battery capacity, the present rechargeable battery capacity, or similar, of the different rechargeable battery packs may be taken into account.

Advantageously, provision may be made for the power bank module to comprise at least two supply connections, and for the controller to be configured to control an opening and closing of circuits between the plurality of rechargeable battery ports, the at least two supply connections and the charging connection in such a way that two closed circuits, which are isolated from one another and each comprise one of the at least two supply connections, in each case always comprise only one rechargeable battery port of the plurality of rechargeable battery ports, while all of the others of the plurality of rechargeable battery ports are electrically isolated from the respective supply connection. In particular, provision may be made for the two rechargeable battery ports in the two closed circuits, which are isolated from one another, to be different. As a result of the division into circuits isolated from one another, every load connected to a supply connection may always be fed from a single rechargeable battery pack. This simplifies the voltage regulation required for operating the power bank module, since neither a parallel connection nor a series connection of the rechargeable battery packs, which may have different performance data, has to be considered.

Provision may also be made for the controller to also be configured to control the opening and closing of circuits between the plurality of rechargeable battery ports, the supply connection and the charging connection in such a way that the rechargeable battery port respectively comprised by the two closed circuits changes cyclically. This makes it possible, during operation of the power bank module for supplying power to one or more connected loads, in which care is taken to keep the operating state of the connected rechargeable battery packs similar to one another, to also implement charging of the connected rechargeable battery packs, in which similar states of charge of the connected rechargeable battery packs are maintained.

Advantageously, provision may be made for the opening and closing of circuits between the plurality of rechargeable battery ports, the supply connection and the charging connection to be controlled by the controller in such a way that the charging connection and the at least one supply connection are always electrically isolated from one another, and that a closed circuit that comprises the charging connection always comprises only one rechargeable battery port of the plurality of rechargeable battery ports, while all of the others of the plurality of rechargeable battery ports are electrically isolated from the charging connection. This prevents a charging current from being “looped through” to a connected load. The charging regulation of the individual connected rechargeable battery packs is also simplified, since there is no parallel or series charging of a plurality of connected rechargeable battery packs. In order to again keep the operating states of the connected rechargeable battery packs essentially the same as one another, there may again be a cyclical change between the rechargeable battery packs. The other parameters mentioned above in connection with supplying power to an electrical load may be used again analogously to control of the change.

Advantageously, provision may be made for the plurality of rechargeable battery ports arranged on the PCB to each comprise a first magnet and a second magnet. The magnets may hold the rechargeable battery packs in their connection position on the respective rechargeable battery port. The electrical contacts themselves may be implemented using individual spring-preloaded pins that are pushed together telescopically under load in their direction of extension and press against flat or smooth associated electrical contact surfaces (pogo pins).

Also described is a power bank comprising such a power bank module, and at least two rechargeable battery packs that are functionally connected to the power bank module. The rechargeable battery packs may themselves also comprise two magnets that interact with any magnets provided on the rechargeable battery ports when the rechargeable battery packs are held in their connection position and provide anti-rotation protection.

The described power bank module may therefore be part of a power bank that, in addition to the power bank module, comprises at least two rechargeable battery packs connected to the rechargeable battery ports. The power bank may in turn be part of a battery system in which the power bank is connected to an electrical load in the form of a further rechargeable battery pack. The battery system may in turn be part of a helmet light system, wherein the helmet light of the helmet light system is fed with electrical energy from the rechargeable battery pack that is connected to the power bank as an electrical load.

In the method, according to the invention, for operating a power bank module, provision is made for an opening and closing of circuits between the plurality of rechargeable battery ports, the at least one supply connection and the charging connection to be controlled by a controller in such a way that a closed circuit that comprises the at least one supply connection always comprises only one rechargeable battery port of the plurality of rechargeable battery ports, while all of the others of the plurality of rechargeable battery ports are electrically isolated from the at least one supply connection. In this way, the advantages and special features of the helmet light according to the invention may also be implemented in the context of a method.

Usefully, provision may be made for the power bank module to comprise at least two supply connections, and for an opening and closing of circuits between the plurality of rechargeable battery ports, the at least two supply connections and the charging connection to be controlled by the controller in such a way that two closed circuits, which are isolated from one another and each comprise one supply connection of the at least two supply connections, in each case always comprise only one rechargeable battery port of the plurality of rechargeable battery ports, while all of the others of the plurality of rechargeable battery ports are electrically isolated from the respective supply connection of the at least two supply connections.

Advantageously, provision may be made for the opening and closing of circuits between the plurality of rechargeable battery ports, the at least one supply connection and the charging connection to be controlled by the controller in such a way that the charging connection and the at least one supply connection are always electrically isolated from one another, and that a closed circuit that comprises the at least one charging connection always comprises only one rechargeable battery port of the plurality of rechargeable battery ports, while all of the others of the plurality of rechargeable battery ports are electrically isolated from the charging connection.

In the figures:

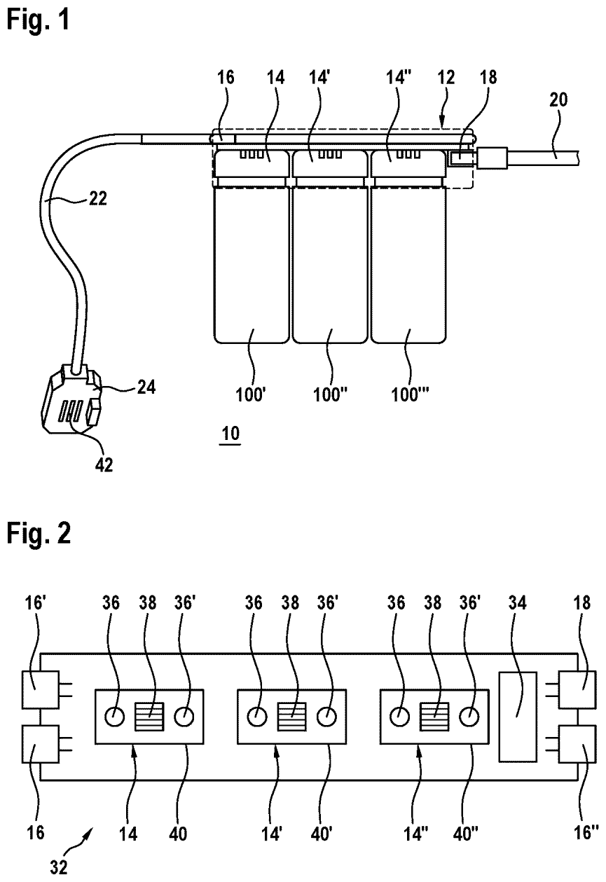

FIG. 1 shows a schematic illustration of an exemplary power bank;

FIG. 2 shows a plan view of a stylized exemplary PCB;

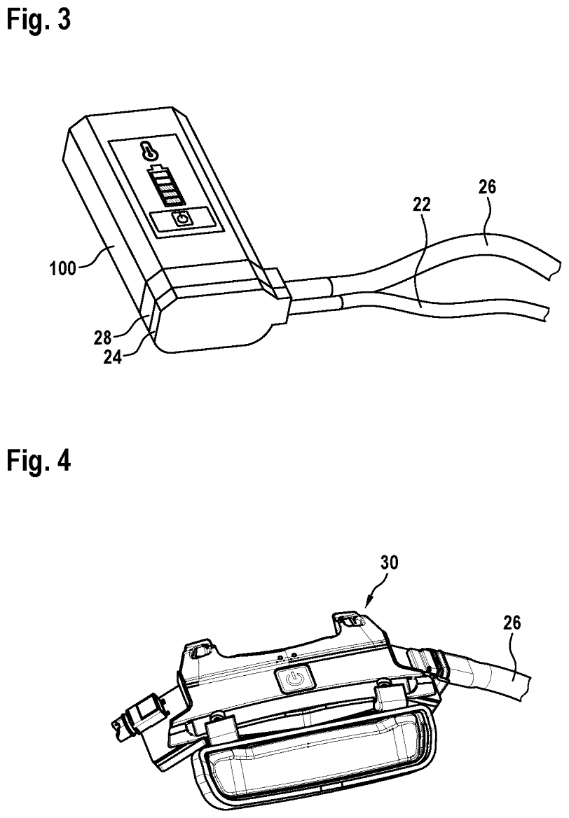

FIG. 3 shows a three-dimensional view of an exemplary rechargeable battery pack; and

FIG. 4 shows a three-dimensional illustration of an exemplary helmet light.

In the following designations, the same reference signs denote the same or functionally similar elements.

FIG. 1 shows a schematic illustration of an exemplary power bank 10. The illustrated power bank 10 consists essentially of a power bank module 12, on which a first rechargeable battery port 14, a second rechargeable battery port 14′ and a third rechargeable battery port 14″ are arranged. It is optionally possible in this case for additional further rechargeable battery ports to be arranged on the power bank module 12. A supply connection 16 and a charging connection 18 are also provided on the power bank module 12. A charging cable 20 is shown plugged into the charging connection 18 in FIG. 1, via which charging cable the power bank 10 is able to be supplied with electrical energy from an external source. This supplied electrical energy may be stored by the power bank 10. For this purpose, in FIG. 1, a first further rechargeable battery pack 100′ is plugged in the first rechargeable battery port 14, a second further rechargeable battery pack 100″ is plugged in the second rechargeable battery port 14′ and a third further rechargeable battery pack 100″′ is plugged in the third rechargeable battery port 14″. Control logic of the power bank module 12 may store the electrical energy supplied via the charging cable 20 in the further rechargeable battery packs 100′, 100″ and 100″′ in a suitable manner, wherein the further rechargeable battery packs 100′, 100″, 100″′ are charged during this process. The charging of the further rechargeable battery packs 100′, 100″, 100′″ may be such that the individual further rechargeable battery packs 100′, 100″, 100″′ are alternately charged so that the respective states of charge of the individual further rechargeable battery packs 100′, 100″, 100″′ are kept at a similar level.

The control logic of the power bank module 12 may thus be configured in such a way that only one rechargeable battery pack of the further rechargeable battery packs 100′, 100″, 100″′ is ever charged, wherein the control logic of the power bank module 12 is able to simultaneously ensure, by way of a cyclical change between the further rechargeable battery packs 100′, 100″ and 100″′, that the respective states of charge of the further rechargeable battery packs 100′, 100″, 100″′ remain or are kept essentially the same as one another.

The further rechargeable battery packs 100′, 100″, 100′″ may in particular be of identical design, which consequently means that the first rechargeable battery port 14, the second rechargeable battery port 14′ and the third rechargeable battery port 14″ are also of identical design.

The supply connection 16, which has already been mentioned, and into which, in FIG. 1, a connection charging cable 22 is plugged that in turn leads to a charging plug 24 with contact pins 42 that are only indicated in FIG. 1, is provided on the power bank module 12. Proceeding from the supply connection 16, an electrical load, which is not shown in FIG. 1, may be coupled to the power bank 10 via the connection charging cable 22 using the charging plug 24 and the contact pins 42. It is optionally possible for the power bank module 12 to have more than one supply connection 16.

The control logic of the power bank module 12 may be designed in such a way that an electrical load connected to the power bank 10 via the connection charging cable 22 and the charging plug 24 at the supply connection 16 is in each case only electrically connected to one of the further rechargeable battery packs 100′, 100″, 100″′ at any time. Accordingly, electrical energy is taken from in each case only one of the further rechargeable battery packs 100′, 100″, 100″′ at the same time to supply power to the connected electrical load. In order, in a manner similar to that when charging the further rechargeable battery packs 100′, 100″, 100″′, to keep a state of charge of the further rechargeable battery packs 100′, 100″, 100″′ essentially the same as one another, provision may be made in this context for the control logic of the power bank module 12 to change cyclically between the further rechargeable battery packs 100′, 100″ and 100″′ so that essentially the same amounts of energy are taken alternately from each of the further rechargeable battery packs 100′, 100″, 100″′ during a discharging process and supplied to a connected electrical load.

It is conceivable, during a discharging process of one of the further rechargeable battery packs 100′, 100″, 100″′, for another one of the further rechargeable battery packs 100′, 100″, 100″′ to be simultaneously charged. It is also possible for the power bank module 12 to be connected to another power bank via the charging connection 18 and the charging cable 20 arranged thereon, wherein the power bank 10 may then be regarded as an electrical load for the other power bank, which is not shown. It is also possible for the charging cable 20 to lead into a commercially available charging device, which, for example, is supplied with electrical energy from a public grid and provides said energy in a suitable manner to the power bank 10.

The cyclical change between the further rechargeable battery packs 100′, 100″, 100″′ during the charging/discharging processes may, for example, be effected in a time-controlled manner. By way of example, it is conceivable for a change to be effected by the control logic during a charging/discharging process at the latest every 15 minutes, preferably after 10 minutes, particularly preferably after 5 minutes. The exact time period after which a change to the next further rechargeable battery pack 100′, 100″, 100′″ should be effected may be stored, for example, in the respective further rechargeable battery pack 100′, 100″, 100″′ as a parameter that is able to be read by the power bank module. In addition to simple cyclical time control for changing between the further rechargeable battery packs 100′, 100″, 100″′, control based on another measurable parameter is also possible, for example a temperature of the further rechargeable battery packs 100′, 100″, 100″′ in order to limit a temperature difference between the further rechargeable battery packs 100′, 100″, 100′″ or the amount of energy taken, etc.

If the power bank 10 has a plurality of supply connections 16, the control logic of the power bank module 12 may be designed in such a way that in each case one of the further rechargeable battery packs 100′, 100″, 100″′ is electrically connected to precisely one of the supply connections, and so virtually every electrical load connected to the power bank 10 via one of the supply connections 16 is electrically connected to a “dedicated” further rechargeable battery pack 100′, 100″, 100″′ and is supplied with electrical energy thereby. In this case, too, there may be a cyclical change between the existing further rechargeable battery packs 100′, 100″, 100″′. Electrically connecting only one further rechargeable battery pack 100′, 100″, 100″′ to the charging connection 18 or the supply connection 16 in each case simplifies the voltage regulation, since neither a parallel connection nor a series connection of the further rechargeable battery packs 100′, 100″, 100″′ present has to be taken into account.

The control logic of the power bank module 12 may enable communication between the power bank 10 and all of the components connected to the power bank module 10, for example by way of a UART protocol. It is therefore possible for the electrical load connected to the supply connection 16 to communicate both with the control logic of the power bank module 12 and with the further rechargeable battery packs 100′, 100″, 100″′ connected thereto in each case. The same applies to the control logic of the power bank module 12 and a charging device, potentially connected to the power bank 10 via the charging cable 20, or a further power bank. By way of example, it is conceivable for a cell phone to be connected to the power bank 10 via the charging connection 18, wherein it is possible to use different functions of the cell phone on account of the power bank 10 by way of the provided communication between the control logic of the power bank module 12 and the connected cell phone. By way of example, it is possible to use the cell phone to carry out GPS localization of the power bank 10. It is also possible to transmit an emergency call by way of the cell phone or to control loads connected to the power bank by way of the cell phone.

The supply connection 16 and the charging connection 18 may be designed to be pin-compatible so that it does not matter for the power bank 10 or the power bank module 12 where an electrical load is connected or where a charging device is connected. It is possible to determine whether the respective connection is acting as a supply connection 16 or as a charging connection 18 using the established communication between the connected device and the control logic of the power bank module 12, for example.

FIG. 2 shows a simplified plan view of an exemplary PCB 32. The illustrated PCB 32 comprises the rechargeable battery ports 14, 14′ and 14″ that are already previously known from FIG. 1, the supply connection 16 and the charging connection 18. In addition to the supply connection 16, further supply connections 16′, 16″ are shown. As already explained in connection with FIG. 1, the connections 16, 16′, 16″, 18 may be designed to be pin-compatible. By way of example, it is possible for the connections 16, 16′, 16″, 18 to each be in the form of USB-C connections. The provision of other connection types, for example jack plugs, is of course also possible, as is the different configuration between the supply connections 16, 16′, 16″ and the charging connection 18. In addition to the connections 16, 16′, 16″ and 18, the PCB 32 of the power bank module 12 also carries the rechargeable battery ports 14, 14′, 14″ that are also already known from FIG. 1. Said rechargeable battery ports are shown in a plan view in FIG. 2 in such a way that the further rechargeable battery packs 100′, 100″, 100′″ would each be plugged in (from above into the plane of the drawing). The further rechargeable battery packs 100′, 100″, 100″′ are inserted into a respective frame 40, 40′, 40″ until they finally abut the base of the respective rechargeable battery port 14, 14′, 14″. In this case, the respective connection contacts 38 form electrical connections with the associated electrical contacts of the further rechargeable battery packs 100′, 100″, 100″′. First and second magnets 36, 36′ are shown by way of example in FIG. 2 on both sides of the connection contacts in the respective rechargeable battery ports 14, 14′, 14″, said magnets being able to hold inserted further rechargeable battery packs 100′, 100″, 100″′ in the inserted connection position. In order to implement anti-rotation protection when inserting the further rechargeable battery packs 100′, 100″, 100″′, the further rechargeable battery packs 100′, 100″, 100″′ may also have magnets that, when suitably oriented in cooperation with the first magnet 36 and the second magnet 36′, exert attractive (correct orientation) or repulsive (incorrect orientation) forces on the respective further rechargeable battery pack 100′, 100″, 100″′.

The control of the power bank 10 and the power bank module 12 in the form of control logic, which is indicated by way of example above in connection with FIG. 1, is carried out by way of example in FIG. 2 by a controller 34 that is connected to, and is able to communicate with, the other components of the power bank module 12 that are arranged on the PCB 32 by way of conductor paths that are not shown. Of course, the controller 34 should be understood merely as an example, and so all or at least some of the described functionalities may also be implemented with separate electronic components. Complete integration into a single microchip is accordingly conceivable, but not necessary. For reasons of space, it is conceivable for the controller 34 to be arranged on the side of the PCB 32 that is opposite to the rechargeable battery ports 14, 14′, 14″ in order to save space.

FIG. 3 shows a three-dimensional view of an exemplary rechargeable battery pack 100. The illustrated rechargeable battery pack 100 may be identical to the further rechargeable battery packs 100′, 100″, 100″′ in terms of the technical specifications thereof, in particular the capacity, the internal structure and the communication capability thereof. However, FIG. 3 does not show the rechargeable battery pack 100 inserted into the power bank module 12, but rather connected to an exemplary helmet light 30, which is shown in a three-dimensional manner in FIG. 4, and which acts as an electrical load for the rechargeable battery pack 100, via a connecting plug 28 and a connecting cable 26. At the same time, the rechargeable battery pack 100 is connected to the power bank module 12 via the charging plug 24, which is already known from FIG. 1, using the connection cable 22, and so the rechargeable battery pack 100 acts as an electrical load for the power bank 10, said electrical load being connected to a supply connection 16 of the power bank module 12, and is charged in this way.

On account of the above-described configuration, in which the helmet light 30 shown in FIG. 4 is first electrically connected to the rechargeable battery pack 100 and then the rechargeable battery pack 100 is in turn connected to the power bank 10, the rechargeable battery pack 100 remains substantially charged until the further rechargeable battery packs 100′, 100″, 100″′ arranged in the power bank 10 are completely discharged. Even after removing the power bank 10 from the rechargeable battery pack 100, that is to say by removing the charging plug 24 at the rechargeable battery pack 100, there is therefore no interruption of the power supply to the helmet light 30, which is still connected to the rechargeable battery pack 100.

The power bank 10 may have holding elements, which are not shown, for example loops, using which the power bank 10 is able to be fastened to a belt, for example. It is also conceivable for the power bank 10 to have a hook-and-loop surface, using which it is able to be detachably fixed in a storage pocket, for example. By way of example, the storage pocket may be an inside pocket of a jacket, for example of a cut protection vest.

The features of the invention that are disclosed in the above description, in the drawings and in the claims may be essential for the implementation of the invention both individually and in any desired combination.

### LIST OF REFERENCE SIGNS

10 Power bank
12 Power bank module
14 First rechargeable battery port
14′ Second rechargeable battery port
14″ Third rechargeable battery port
16 Supply connection
16′ Further supply connection
16″ Further supply connection
18 Charging connection
20 Charging cable
22 Connection charging cable
24 Charging plug
26 Connecting cable
28 Connecting plug
30 Helmet light
32 PCB
34 Controller
36 First magnet
36′ Second magnet
38 Connection contacts
40 Frame
40′ Frame
40″ Frame
42 Contact pins
100 Rechargeable battery pack
100′ First further rechargeable battery pack
100″ Second further rechargeable battery pack
100″′ Third further rechargeable battery pack

1.-11. (canceled)

12. A power bank module comprising:
a PCB with a controller arranged thereon;
a plurality of rechargeable battery ports that are arranged on the PCB and are configured to establish a functional connection between a number of rechargeable battery packs, which are able to be connected to the plurality of rechargeable battery ports, and the power bank module;
at least one supply connection that is arranged on the PCB and to which a load is able to be connected, wherein the supply connection is configured to establish a functional connection between the connected load and the power bank module;
a charging connection that is arranged on the PCB and to which an energy source is able to be connected, wherein the charging connection is configured to establish a functional connection between the energy source and the power bank module;
wherein the controller is configured to control an opening and closing of circuits between the plurality of rechargeable battery ports, the at least one supply connection and the charging connection in such a way that a closed circuit that comprises the at least one supply connection always comprises only one rechargeable battery port of the plurality of rechargeable battery ports, while all of the others of the plurality of rechargeable battery ports are electrically isolated from the supply connection.

13. The power bank module as claimed in claim 11, wherein the controller is also configured to control the opening and closing of circuits between the plurality of rechargeable battery ports, the supply connection and the charging connection in such a way that the rechargeable battery port comprised by the closed circuit changes cyclically.

14. The power bank module as claimed in claim 13, wherein the cyclical change between the rechargeable battery ports is effected in a time-controlled manner or on the basis of another measurable parameter.

15. The power bank module as claimed in claim 12, wherein the power bank module comprises at least two supply connections, and wherein the controller is configured to control an opening and closing of circuits between the plurality of rechargeable battery ports, the at least two supply connections and the charging connection in such a way that two closed circuits, which are isolated from one another and each comprise one of the at least two supply connections, in each case always comprise only one rechargeable battery port of the plurality of rechargeable battery ports, while all of the others of the plurality of rechargeable battery ports are electrically isolated from the respective supply connection.

16. The power bank module as claimed in claim 15, wherein the controller is also configured to control the opening and closing of circuits between the plurality of rechargeable battery ports, the at least one supply connection and the charging connection in such a way that the rechargeable battery port respectively comprised by the two closed circuits changes cyclically.

17. The power bank module as claimed in claim 12, wherein the controller is also configured to control the opening and closing of circuits between the plurality of rechargeable battery ports, the at least one supply connection and the charging connection in such a way that the charging connection and the at least one supply connection are always electrically isolated from one another, and that a closed circuit that comprises the charging connection always comprises only one rechargeable battery port of the plurality of rechargeable battery ports, while all of the others of the plurality of rechargeable battery ports are electrically isolated from the charging connection.

18. The power bank module as claimed in claim 12, wherein the plurality of rechargeable battery ports arranged on the PCB each comprise a first magnet and a second magnet.

19. A power bank comprising:
a power bank module as claimed in claim 12, and at least two rechargeable battery packs that are functionally connected to the power bank module.

20. A method for operating a power bank as claimed in claim 19, wherein an opening and closing of circuits between the plurality of rechargeable battery ports, the at least one supply connection and the charging connection is controlled by a controller in such a way that a closed circuit that comprises the at least one supply connection always comprises only one rechargeable battery port of the plurality of rechargeable battery ports, while all of the others of the plurality of rechargeable battery ports are electrically isolated from the at least one supply connection.

21. The method as claimed in claim 20, wherein the power bank module comprises at least two supply connections, and wherein an opening and closing of circuits between the plurality of rechargeable battery ports, the at least two supply connections and the charging connection is controlled by the controller in such a way that two closed circuits, which are isolated from one another and each comprise one supply connection of the at least two supply connections, in each case always comprise only one rechargeable battery port of the plurality of rechargeable battery ports, while all of the others of the plurality of rechargeable battery ports are electrically isolated from the respective supply connection of the at least two supply connections.

22. The method as claimed in claim 20, wherein the opening and closing of circuits between the plurality of rechargeable battery ports, the at least one supply connection and the charging connection is controlled by the controller in such a way that the charging connection and the at least one supply connection are always electrically isolated from one another, and that a closed circuit that comprises the at least one charging connection always comprises only one rechargeable battery port of the plurality of rechargeable battery ports, while all of the others of the plurality of rechargeable battery ports are electrically isolated from the charging connection.
